(19) United States
(12) Patent Application Publication
(10) Pub. No.: US 2025/0201947 A1
(43) Pub. Date: Jun. 19, 2025

(54) TEST SYSTEM AND METHOD FOR ALL-SOLID RECHARGEABLE BATTERY

(71) Applicant: SAMSUNG SDI CO., LTD., Yongin-si (KR)

(72) Inventors: Hye-Jung LEE, Yongin-si (KR); Jongsan IM, Yongin-si (KR); Hidekazu YAMAMOTO, Yokohama-shi (JP); Takayoshi FUJITA, Yokohama-shi (JP)

(21) Appl. No.: 18/945,884

(22) Filed: Nov. 13, 2024

(30) Foreign Application Priority Data
Dec. 18, 2023 (KR) 10-2023-0185096

(51) Int. Cl. H01M 10/42; G01N 15/0227; H01M 10/44

(52) U.S. Cl. CPC H01M 10/4285; G01N 15/0227; H01M 10/44

(57) ABSTRACT

An embodiment provides a test system for an all-solid rechargeable battery, including: a cut surface forming apparatus that forms a cut surface on a battery specimen including a positive electrode, a negative electrode, and a solid electrolyte layer, and a cut surface test apparatus that tests the cut surface of the battery specimen, wherein the cut surface test apparatus includes a first elastic member loading portion that positions first elastic members on both surfaces of the battery specimen, a first pressing portion that presses both surfaces of the battery specimen, and an optical test portion that optically tests the cut surface, and the first elastic member loading portion aligns the first elastic member so that a side surface of the first elastic member protrudes more than the cut surface of the battery specimen.

### CROSS-REFERENCE TO RELATED APPLICATION

This application claims priority to and the benefit of Korean Patent Application No. 10-2023-0185096 filed in the Korean Intellectual Property Office on Dec. 18, 2023, the entire contents of which are incorporated herein by reference.

### BACKGROUND

### Field

The present disclosure relates to a test system and method for an all-solid rechargeable battery.

### Description of the Related Art

Recently, the risk of batteries using liquid electrolytes exploding has been reported and development of all-solid rechargeable batteries is being conducted. An all-solid rechargeable battery (also referred to as a solid-state battery) is a battery in which all materials are made of solid and refers to a battery in which a solid electrolyte is used. An all-solid secondary battery has advantages in that the battery is safer because there is no risk of explosion due to electrolyte leakage, is easy to manufacture as a thin battery, has a high energy density, and is capable of implementing large capacity.

The above information disclosed in this background section is only for enhancement of understanding of the background of the disclosure, and therefore it may contain information that does not form the prior art that is already known in this country to a person of ordinary skill in the art.

### SUMMARY

Embodiments provide a test system and method for an all-solid rechargeable battery that minimize damage to a cut surface of a battery specimen and protect the cut surface to accurately and reliably test the battery specimen. However, the technical problem to be solved by the present disclosure is not limited in this regard, and other objects not mentioned herein will be understood from the following description by those skilled in the art.

An embodiment provides a test system for an all-solid rechargeable battery, including: a cut surface forming apparatus configured to form a cut surface on a battery specimen that includes a positive electrode, a negative electrode, and a solid electrolyte layer, and a cut surface test apparatus configured to test the cut surface of the battery specimen, wherein the cut surface test apparatus includes a first elastic member loading portion configured to position elastic members on opposite surfaces of the battery specimen, a pressing portion that presses the opposite surfaces of the battery specimen, and an optical test portion configured to optically test the cut surface, and the elastic member loading portion configured to align the elastic members so that side surfaces of the elastic members protrude more than the cut surface of the battery specimen.

The first pressing portion may include pressing plates contact with both surfaces of the elastic members, and a pressure providing portion that provides pressure to the pressing plates, and the first pressing portion may be configured to align the pressing plates so that side surfaces of the pressing plates protrude more than side surfaces of the elastic members.

The elastic member loading portion may be configured to attach an alignment member to the battery specimen by allowing an edge portion of the alignment member to protrude further than the cut surface of the battery specimen, and the elastic member loading portion may be configured to allow the edge portion of the alignment member to be aligned on the the side surfaces of the elastic members.

The cut surface forming apparatus may include a second elastic member loading portion that is configured to position second elastic members on the opposite surfaces of the battery specimen, a second pressing portion that is configured to press the second elastic members and the battery specimen, and a cutting portion of the cut surface forming apparatus that is configured to cut a portion of the battery specimen and the second elastic members to form the cut surface on the battery specimen.

The cut surface forming apparatus may further include a cut surface processing portion that is configured to surface-process the cut surface.

The cut surface processing portion may include a polishing portion that is configured to form a polishing groove by polishing a portion of the cut surface, and a protective member forming portion that is configured to form a protective member on the cut surface.

The cutting portion may include a cross-sectional blade.

The cut surface test apparatus may further include a chamber in which the pressing plates are disposed, and the chamber may include a chamber body that blocks the pressing plate from outside of the chamber body, and a test window that is installed on the chamber body and disposed to correspond to the cut surface of the battery specimen.

The cut surface test apparatus may further include a charging/discharging portion that is configured to be electrically connected to an electrode tab of the battery specimen and to charge and discharge the battery specimen.

Another embodiment provides a test method for an all-solid rechargeable battery, including: forming a cut surface on a battery specimen that includes a positive electrode, a negative electrode, and a solid electrolyte layer; and testing the cut surface of the battery specimen, wherein the testing of the cut surface includes positioning elastic members on opposite surfaces of the battery specimen, aligning side surfaces of the elastic members so that the side surfaces of the elastic members protrude more than the cut surface of the battery specimen, pressing surfaces of the elastic members and the battery specimen using a pressing portion, and optically testing the cut surface.

The first pressing portion may include pressing plates in contact with surfaces of the elastic members, and a pressure providing portion that provides pressure to the pressing plates, and in the pressing of both surfaces of the battery specimen, side surfaces of the pressing plates may be aligned so that the side surface of the pressing plates protrude more than side surfaces of the elastic members.

The forming of the cut surface on the battery specimen may include positioning second elastic members on the opposite surfaces of the battery specimen, pressing the second elastic members and the battery specimen, and forming the cut surface by cutting a portion of the battery specimen and the second elastic members using a cutting portion.

The cutting portion may include a cross-sectional blade.

The forming of the cut surface on the battery specimen may further include surface-processing the cut surface, and the surface-processing of the cut surface may include forming a polishing groove by polishing a portion of the cut surface and forming a protective member on the cut surface.

The testing of the cut surface may further include positioning the pressing plates and the battery specimen inside a chamber body and blocking the pressing plates and the battery specimen from outside of the chamber, and charging and discharging the battery specimen, and the cut surface may be optically tested while charging and discharging the battery specimen through a test window installed in the chamber body.

According to the embodiments, by pressing the battery specimen in a state in which the elastic members are attached, the stack cells in the battery specimen are uniformly adhered to each other on all surfaces of the battery specimen such that when the battery specimen is cut using the cutting portion in the subsequent process, the cut surface may be uniformly formed, and damage to the cut surface may be minimized.

In addition, by pressing in an aligned state so that the side surfaces of the elastic members protrude more than the cut surface of the battery specimen and the side surfaces of the pressing plates protrude more than the side surfaces of the elastic members, the edge portion of the battery specimen adjacent to the cut surface of the battery specimen may be evenly pressed. Therefore, distortion of the battery specimen may be prevented, and the cut surface of the battery specimen may be tested more accurately.

In addition, by treating the surface of the cut surface of the battery specimen and forming a protective member on the cut surface, it is possible to minimize the cut surface contacting air or being physically damaged.

### BRIEF DESCRIPTION OF THE DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 illustrates a cross-sectional view of an all-solid battery.

FIG. 2 illustrates a cross-sectional view of an all-solid battery including a precipitation-type negative electrode.

FIG. 3 schematically illustrates a test system for an all-solid rechargeable battery according to an embodiment.

FIG. 4 illustrates a state in which a battery specimen is pressed by using a second elastic member loading portion and a second pressing portion of FIG. 3.

FIG. 5 illustrates a state in which a portion of a battery specimen is cut by using a cutting portion of FIG. 3.

FIG. 6 illustrates a state in which a polishing groove is formed in a portion of a battery specimen by using a polishing portion of FIG. 3.

FIG. 7 illustrates a state in which a protective member is formed in a polishing groove of a battery specimen by using a protective member forming portion of FIG. 3.

FIG. 8 illustrates a state in which a battery specimen is pressed by using a first elastic member loading portion and a first pressing portion of a cut surface test apparatus of a test system for an all-solid rechargeable battery according to an embodiment.

FIG. 9 illustrates a flowchart of a test method for an all-solid rechargeable battery according to an embodiment.

### DETAILED DESCRIPTION OF THE EMBODIMENTS

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

Unless explicitly described to the contrary, the word “comprise” and variations such as “comprises” or “comprising” will be understood to imply the inclusion of stated elements but not the exclusion of any other elements.

In the drawings, the thicknesses of layers, films, panels, areas, regions, and the like are exaggerated for clarity, and like reference numerals designate like elements throughout the specification. It will be understood that when an element such as a layer, film, region, area or substrate is referred to as being “on” or “above” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface. Here, “or” is not to be construed as an exclusive meaning, and for example, “A or B” is construed to include A, B, A+B, and the like.

### Positive Electrode for All-Solid Rechargeable Battery

In an embodiment, there is provided a positive electrode for an all-solid rechargeable battery including a current collector and a positive electrode active material layer positioned on the current collector, wherein the positive electrode active material layer includes at least one of a positive electrode active material, a sulfide-based solid electrolyte, a binder, and a conductive material. However, the present disclosure is not limited thereto, and the positive electrode for the all-solid rechargeable battery may include more or less components than the above-described components.

In the embodiment, the positive electrode for the all-solid rechargeable battery is manufactured by applying a positive electrode composition including at least one of a positive electrode active material, a sulfide-based solid electrolyte, a binder, and a conductive material to a current collector, followed by drying and roll-pressing.

### Positive Active Material

The positive electrode active material may be applied without limitation in the form of positive electrode active materials that are generally used in all-solid rechargeable batteries. For example, the positive electrode active material may be a compound capable of reversible intercalation and deintercalation of lithium, and may include a compound represented by any one of the following chemical formulas.
LiₐA_{1-b}X_{b}D₂ (0.90≤a≤1.8, 0≤b≤0.5);
Li^{a}A^{1-b}X^{b}O^{2-c}D^{c} (0.90≤a≤1.8, 0≤b≤0.5, 0≤c≤0.05);
LiₐE_{1-b}X_{b}O_{2-c}D_{c} (0.90≤a≤1.8, 0≤b≤0.5, 0≤c≤0.05);
LiₐE_{2-b}X_{b}O_{4-c}D_{c} (0.90≤a≤1.8, 0≤b≤0.5, 0≤c≤0.05);
LiₐNi_{1-b-c}CO_{b}X_{c}D_{α} (0.90≤a≤1.8, 0≤b≤0.5, 0≤c≤0.5, 0<α≤2);
LiₐNi_{1-b-c}CO_{b}X_{c}O_{2-α}T_{α} (0.90≤a≤1.8, 0≤b≤0.5, 0≤c≤0.05, 0<α<2);
LiₐNi_{1-b-c}CO_{b}X_{c}O_{2-α}T₂ (0.90≤a≤1.8, 0≤b≤0.5, 0≤c≤0.05, 0<α<2);
LiₐNi_{1-b-c}Mn_{b}X_{c}D_{α} (0.90≤a≤1.8, 0≤b≤0.5, 0≤c≤0.05, 0<α≤2);
LiₐNi_{1-b-c}Mn_{b}X_{c}O_{2-α}T_{α} (0.90≤a≤1.8, 0≤b≤0.5, 0≤c≤0.05, 0<α<2);
LiₐNi_{1-b-c}Mn_{b}X_{c}O_{2-α}T₂ (0.90≤a≤1.8, 0≤b≤0.5, 0≤c≤0.05, 0<α<2);
LiₐNi_{b}E_{c}G_{d}O₂ (0.90≤a≤1.8, 0≤b≤0.9, 0≤c≤0.5, 0.001≤d≤0.1);
LiₐNi_{b}Co_{c}Mn_{d}GₑO₂ (0.90≤a≤1.8, 0≤b≤0.9, 0≤c≤0.5, 0≤d≤0.5, 0.001≤e≤0.1);
LiₐNiG_{b}O₂ (0.90≤a≤1.8, 0.001≤b≤0.1);
LiₐCoG_{b}O₂ (0.90≤a≤1.8, 0.001≤b≤0.1);
LiₐMn_{1-b}G_{b}O₂ (0.90≤a≤1.8, 0.001≤b≤0.1);
LiₐMn₂G_{b}O₄ (0.90≤a≤1.8, 0.001≤b≤0.1);
LiₐMn_{1-g}G_{g}PO₄ (0.90≤a≤1.8, 0≤g≤0.5);
QO₂; QS₂; LiQS₂;
V₂O₅; LiV₂O₅;
LiZO₂;
LiNiVO₄;
Li_{(3-f)}J₂PO₄₃ (0≤f≤2);
Li_{(3-f)}Fe₂PO₄₃ (0≤f≤2);
LiₐFePO₄ (0.90≤a≤1.8).

In the above chemical formulas, A is selected from the group consisting of Ni, Co, Mn, and a combination thereof; X is selected from the group consisting of Al, Ni, Co, Mn, Cr, Fe, Mg, Sr, V, rare earth elements, and a combination thereof; D is selected from the group consisting of O, F, S, P, and a combination thereof; E is selected from the group consisting of Co, Mn, and a combination thereof; T is selected from the group consisting of F, S, P, and a combination thereof; G is selected from the group consisting of Al, Cr, Mn, Fe, Mg, La, Ce, Sr, V, and a combination thereof; Q is selected from the group consisting of Ti, Mo, Mn, and a combination thereof; Z is selected from the group consisting of Cr, V, Fe, Sc, Y, and a combination thereof; and J is selected from the group consisting of V, Cr, Mn, Co, Ni, Cu, and a combination thereof.

The positive electrode active material may be, for example, lithium cobalt oxide (LCO), lithium nickel oxide (LNO), lithium nickel cobalt oxide (NC), lithium nickel cobalt aluminum oxide (NCA), lithium nickel cobalt manganese oxide (NCM), and lithium nickel manganese oxide (NM), lithium manganese oxide (LMO), or lithium ferrous phosphate oxide (LFP).

The positive electrode active material may include a lithium nickel-based oxide represented by Chemical Formula 1 below, a lithium cobalt-based oxide represented by Chemical Formula 2 below, a lithium ferrous phosphate-based compound represented by Chemical Formula 3 below, or a combination thereof.

Liₐ₁Niₓ₁M¹_{y1}M²_{1-x1-y1}O₂ [Chemical Formula 1]

In Chemical Formula 1, 0.9≤a1≤1.8, 0.3≤x1≤1, 0≤y1≤0.7, and M¹ and M² are each one or more elements independently selected from the group consisting of Al, B, Ba, Ca, Ce, Co, Cr, Cu, F, Fe, Mg, Mn, Mo, Nb, P, S, Si, Sr, Ti, V, W, and Zr.

Liₐ₂Coₓ₂M³₁₋ₓ₂O₂ [Chemical Formula 2]

In Chemical Formula 2, 0.9≤a2≤1.8, 0.6x2≤1, and M³ is one or more elements selected from the group consisting of Al, B, Ba, Ca, Ce, Cr, Cu, F, Fe, Mg, Mn, Mo, Nb, P, S, Si, Sr, Ti, V, W, and Zr.

Liₐ₃Feₓ₃M⁴₍₁₋ₓ₃₎PO₄ [Chemical Formula 3]

In Chemical Formula 3, 0.9≤a3≤1.8, 0.6≤x3≤1, and M⁴ is one or more elements selected from the group consisting of Al, B, Ba, Ca, Ce, Co, Cr, Cu, F, Fe, Mg, Mn, Mo, Nb, P, S, Si, Sr, Ti, V, W, and Zr.

An average particle diameter (D₅₀) of the positive electrode active material may be 1 μm to 25 μm, for example, 3 μm to 25 μm, 5 μm to 25 μm, 5 μm to 20 μm, 8 μm to 20 μm, or 10 μm to 18 μm. The positive electrode active material having the particle diameter range can be harmoniously mixed with other components in the positive electrode active material layer and can implement the high capacity and high energy density.

The positive electrode active material may be in the form of a secondary particle made by agglomeration of a plurality of primary particles, or may be in the form of a single particle. In addition, the positive electrode active material may be spherical or close to a spherical shape, or may be polyhedral or amorphous.

### Sulfide-Based Solid Electrolyte

The sulfide-based solid electrolyte may include, for example, Li₂S—P₂S₅, Li₂S—P₂S₅—LiX (X is a halogen element, for example I, or Cl), Li₂S—P₂S₅—Li₂O, Li₂S—P₂S₅—Li₂O-LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are each an integer, and Z is Ge, Zn, or Ga), Li₂S—GeS₂, Li₂S—SiS₂—Li₃PO₄, Li₂S—SiS₂—LiₚMO_{q} (p and q are integers, and M is P, Si, Ge, B, Al, Ga, or In), or a combination thereof.

The sulfide-based solid electrolyte may be obtained by, for example, mixing Li₂S and P₂S₅ at a molar ratio of 50:50 to 90:10 or 50:50 to 80:20 and optionally heat treating the mixture. Within the mixing ratio range, a sulfide-based solid electrolyte having excellent ionic conductivity may be manufactured. Here, SiS₂, GeS₂, B₂S₃, and the like as other components may be further included to further improve the ionic conductivity.

A mechanical milling or solution method may be applied as a method of mixing sulfur-containing raw materials to prepare the sulfide-based solid electrolyte. Mechanical milling is a method of particulating and mixing starting materials by putting the starting materials, a ball mill, and the like in a reactor and stirring strongly the mixture. When using the solution method, the solid electrolyte may be obtained as a precipitate by mixing the starting materials in a solvent. In addition, when heat treatment is performed after mixing, crystals of the solid electrolyte may become more robust and the ionic conductivity may be improved. As an example, the sulfide-based solid electrolyte may be prepared by mixing sulfur-containing raw materials and heat-treating the sulfur-containing raw materials twice. In this case, the sulfide-based solid electrolyte having high ionic conductivity and robustness may be prepared.

As an example, the sulfide-based solid electrolyte particles may contain argyrodite type sulfide. The argyrodite type sulfide may be expressed by, for example, LiₐM_{b}P_{c}S_{d}Aₑ (a, b, c, d, and e all are 0 or more to 12 or less, M is Ge, Sn, Si, or a combination thereof, A is F, Cl, Br, or I), and as a specific example, may be expressed by Chemical Formula of Li₇₋ₓPS₆₋ₓAₓ (x is 0.2 or more and 1.8 or less, and A is F, Cl, Br, or I). The argyrodite type sulfide may specifically be Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, or the like.

The sulfide-based solid electrolyte particles containing such argyrodite type sulfide may have high ionic conductivity close to the range of 10⁻⁴ to 10⁻² S/cm, which is ionic conductivity of a typical liquid electrolyte at room temperature, and may form a tight bond between the positive active material and the solid electrolyte without causing the decrease in the ion conductivity, and further form a tight interface between the electrode layer and the solid electrolyte layer. The all-solid rechargeable battery containing such an argyrodite type sulfide may improve the performance of the battery in relation to rate characteristics, coulombic efficiency, and lifespan characteristics.

The argyrodite type sulfide-based solid electrolyte may be prepared by, for example, mixing lithium sulfide, phosphorus sulfide, and optionally lithium halide. After mixing, heat treatment may be performed. The heat treatment may include, for example, two or more heat treatment steps.

The average particle size D₅₀ of the sulfide-based solid electrolyte particles according to an embodiment may be 5.0 μm or less and may be, for example, 0.1 μm to 5.0 μm, 0.1 μm to 4.0 μm, 0.1 μm to 3.0 μm, 0.5 μm to 2.0 μm, or 0.1 μm to 1.5 μm. Alternatively, the sulfide-based solid electrolyte particles may be small particles having the average particle size D₅₀ of 0.1 μm to 1.0 μm depending on the location or purpose of use, or may be large particles having an average particle size D₅₀ of 1.5 μm to 5.0 μm. The sulfide-based solid electrolyte particles in this particle size range may effectively penetrate between the solid particles in the battery, and have excellent contactability with the electrode active material and the connectivity between the solid electrolyte particles. The average particle size of the sulfide-based solid electrolyte particles may be measured using a microscope image. For example, the particle size distribution may be obtained by measuring the size of about 20 particles in a scanning electron microscope image, and the D₅₀ may be calculated from the particle size distribution.

The content of the solid electrolyte in the positive electrode for the all-solid rechargeable battery may be 0.5 wt % to 35 wt % and may be, for example, 1 wt % to 35 wt %, 5 wt % to 30 wt %, and 8 wt % to 25 wt %, or 10 wt % to 20 wt %. This is the content relative to the total weight of the components in the positive electrode, and specifically, may be the content relative to the total weight of the positive electrode active material layer.

In the embodiment, the positive electrode active material layer contains 50 wt % to 99.35 wt % of positive electrode active material, 0.5 wt % to 35 wt % of sulfide-based solid electrolyte, and 0.1 wt % to 10 wt % of fluorinated resin binder, and 0.05 wt % to 5 wt % of vanadium oxide, based on 100 wt % of positive electrode active material layer. When this content range is satisfied, the positive electrode for the all-solid rechargeable battery maintains the high adhesion while maintaining the high capacity and high ionic conductivity, and maintains the viscosity of the positive electrode composition at an appropriate level, thereby improving the processability.

### Binder

The binder serves to appropriately bind positive electrode active material particles to each other and appropriately bind the positive electrode active material to the current collector. As a representative example of the binder, polyvinylalcohol, carboxymethylcellulose, hydroxypropylcellulose, diacetylcellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, an epoxy resin, nylon, or the like, may be used, but the binder is not limited thereto.

### Conductive Material

The positive electrode active material layer may further include a conductive material. The conductive material is used to provide conductivity to an electrode, and may include, for example, a carbon-based material such as natural graphite, artificial graphite, carbon black, acetylene black, Ketjen black, a carbon fiber, and a carbon nanotube; a metal-based material in the form of metal powder or metal fiber containing copper, nickel, aluminum, silver, and the like; a conductive polymer such as a polyphenylene derivative; or a combination thereof.

The conductive material may be included in an amount of 0.1 wt % to 5 wt %, or 0.1 wt % to 3 wt % with respect to a total weight of each component of the positive electrode for an all-solid-state battery, or with respect to the total weight of the first positive electrode active material layer. Within the above content range, the conductive material can improve electrical conductivity without deteriorating battery performance.

When the positive electrode active material layer further includes a conductive material, the positive electrode active material layer may include 45 wt % to 99.25 wt % of the positive electrode active material, 0.5 wt % to 35 wt % of the sulfide-based solid electrolyte, 0.1 wt % to 10 wt % of the fluorine-based resin binder, 0.05 wt % to 5 wt % of the vanadium oxide, and 0.1 wt % to 5 wt % of the conductive material with respect to 100 wt % of the positive electrode active material layer.

The positive electrode for a lithium rechargeable battery may further include an oxide-based inorganic solid electrolyte, in addition to the solid electrolyte described above. The oxide-based inorganic solid electrolyte may include, for example, Li₁₊ₓTi₂₋ₓAl PO₄₃(LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃(PLZT) (0≤x<1, 0≤y<1), PB(Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}PO₄₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, garnet-based ceramics Li₃₊ₓLₐ₃M₂O₁₂ (M=Te, Nb, or Zr; x is an integer from 1 to 10), or a combination thereof.

### All-Solid Rechargeable Battery

An embodiment provides an all-solid rechargeable battery including the positive electrode described above, a negative electrode, and a solid electrolyte layer positioned between the positive electrode and the negative electrode. The all-solid rechargeable battery may be referred to as an all-solid battery, solid state battery, or an all-solid lithium rechargeable battery.

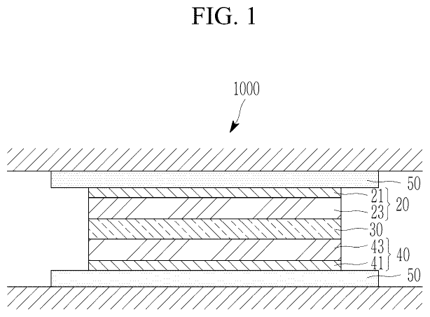

FIG. 1 illustrates a cross-sectional view of an all-solid battery.

Referring to FIG. 1, an all-solid battery 1000 may have a structure in which an electrode assembly in which a negative electrode 40 including a negative electrode current collector 41 and a negative electrode active material layer 43, a solid electrolyte layer 30, and a positive electrode 20 including a positive electrode active material layer 23 and a positive electrode current collector 21 are stacked and accommodated in a case such as a pouch. The all-solid battery 1000 may further include an elastic layer 50 on an outer side of at least one of the positive electrode 20 and the negative electrode 40. Although FIG. 1 shows one electrode assembly including the negative electrode 40, the solid electrolyte layer 30, and the positive electrode 20, an all-solid battery may be manufactured by stacking two or more electrode assemblies.

### Negative Electrode

The negative electrode for an all-solid battery may include, for example, a current collector and a negative electrode active material layer disposed on the current collector. The negative electrode active material layer includes a negative electrode active material and may further include a binder, a conductive material, and/or a solid electrolyte.

The negative electrode active material may include a material capable of reversibly intercalation/deintercalating lithium ions, lithium metal, an alloy of lithium metal, a material capable of being doped and undoped with lithium, or a transition metal oxide.

The material capable of reversibly intercalating/deintercalating lithium ions is a carbon-based negative electrode active material, and may include, for example, crystalline carbon, amorphous carbon, or a combination thereof. Examples of the crystalline carbon may include graphite such as amorphous, plate-like, flake-like, spherical or fibrous natural graphite or artificial graphite, and examples of the amorphous carbon may include soft carbon or hard carbon, mesophase pitch carbide, fired coke, and the like.

For the alloy of the lithium metal, an alloy of lithium and one or more metal selected from Na, K, Rb, Cs, Fr, Be, Mg, Ca, Sr, Si, Sb, Pb, In, Zn, Ba, Ra, Ge, Al and Sn may be used.

For the material capable of being doped or undoped with the lithium, a Si-based negative electrode active material or an Sn-based negative electrode active material may be used. Examples of the Si-based negative electrode active material may include silicon, silicon-carbon composite, SiOₓ (0<x<2), and a Si-Q alloy (Q is an element selected from the group consisting of alkali metals, alkali earth metals, Group 13 elements, Group 14 elements, Group 15 elements, Group 16 elements, transition metals, rare-earth elements, and combinations thereof, but is not Si). Examples of the Sn-based negative electrode active material may include Sn, SnO₂, a Sn-R alloy (R is an element selected from the group consisting of alkali metals, alkali earth metals, Group 13 elements, Group 14 elements, Group 15 elements, Group 16 elements, transition metals, rare-earth elements, and combinations thereof, but is not Sn). In addition, a mixture of at least one thereof and SiO₂ may be used. The elements Q and R may be selected and used from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The silicon-carbon composite may be, for example, a silicon-carbon composite including a core including crystalline carbon and a silicon particle and an amorphous carbon coating layer positioned on a surface of the core. The crystalline carbon may be artificial graphite, natural graphite, or a combination thereof. As the amorphous carbon precursor, coal-based pitch, mesophase pitch, petroleum-based pitch, coal-based oil, petroleum-based heavy oil, or polymer resin such as phenol resin, furan resin, and polyimide resin may be used. In this case, a content of silicon may be 10 wt % to 50 wt % with respect to a total weight of the silicon-carbon composite. In addition, a content of the crystalline carbon may be 10 wt % to 70 wt % with respect to the total weight of the silicon-carbon composite, and a content of the amorphous carbon may be 20 wt % to 40 wt % with respect to the total weight of the silicon-carbon composite. In addition, a thickness of the amorphous carbon coating layer may be 5 nm to 100 nm.

An average particle diameter (D₅₀) of the silicon particle may be 10 nm to 20 μm, for example, 10 nm to 500 nm. The silicon particle may be present in an oxidized form, and in this case, an atomic content ratio of Si:O in the silicon particle, which indicates a degree of oxidation, may be 99:1 to 33:67. The silicon particle may be a SiOₓ particle, in which case a range of x in SiOₓ may be greater than 0 and less than 2. Here, the average particle diameter (D₅₀) is measured with a particle size analyzer using a laser diffraction method and refers to a diameter of a particle with a cumulative volume of 50% by volume in the particle size distribution.

The Si-based negative electrode active material or Sn-based negative electrode active material may be used by mixing with a carbon-based negative electrode active material. A mixing ratio of the Si-based negative electrode active material or Sn-based negative electrode active material and the carbon-based negative electrode active material may be 1:99 to 90:10 at a weight ratio.

The content of the negative electrode active material in the negative electrode active material layer may be 95 wt % to 99 wt % with respect to the total weight of the negative electrode active material layer.

In an embodiment, the negative electrode active material layer further include a binder, and optionally, may further include a conductive material. A content of the binder in the negative electrode active material layer may be 1 wt % to 5 wt % with respect to the total weight of the negative electrode active material layer. In addition, when a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to adhere the negative electrode active material particles to each other well and also to adhere the negative electrode active material to the current collector well. The binder may include a water-insoluble binder, a water-soluble binder, or a combination thereof.

Examples of the water-insoluble binder include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

Examples of the water-soluble binder may include a rubber-based binder or a polymer resin binder. The rubber-based binder may be selected from a styrene-butadiene rubber, an acrylated styrene-butadiene rubber, an acrylonitrile-butadiene rubber, an acrylic rubber, a butyl rubber, a fluoro rubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a thickener capable of imparting viscosity may be used together, and the thickener may include, for example, a cellulose-based compound. The cellulose-based compound may include carboxymethyl cellulose, hydroxypropylmethyl cellulose, methyl cellulose, alkali metal salts thereof, or a combination thereof. As the alkali metal, Na, K, or Li may be used. An amount of the thickener used may be 0.1 to 3 parts by weight with respect to 100 parts by weight of the negative electrode active material.

The conductive material is used to provide conductivity to an electrode, and may include, for example, a carbon-based material such as natural graphite, artificial graphite, carbon black, acetylene black, Ketjen black, a carbon fiber, and a carbon nanotube; a metal-based material in the form of metal powder or metal fiber including copper, nickel, aluminum, silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

As another example, the negative electrode for an all-solid-state battery may be a precipitation-type negative electrode. The precipitation-type negative electrode refers to a negative electrode which does not include a negative electrode active material during assembling of a battery but in which lithium metal or the like is precipitated during charging of the battery and serves as a negative electrode active material.

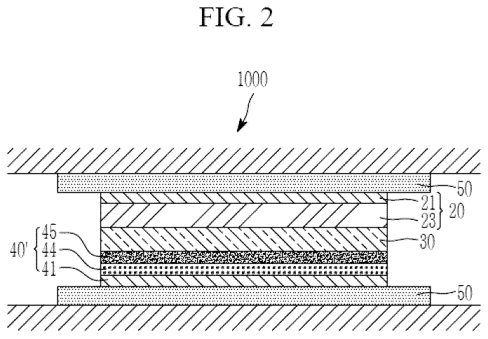

FIG. 2 illustrates a cross-sectional view of an all-solid battery including a precipitation-type negative electrode.

Referring to FIG. 2, a precipitation-type negative electrode 40′ may include a current collector 41 and a negative electrode coating layer 45 disposed on the current collector. In an all-solid battery having the precipitation-type negative electrode 40′, initial charging begins in the absence of a negative electrode active material, and during the charging, lithium metal with a high density or the like is precipitated between the current collector 41 and the negative electrode coating layer 45 and forms a lithium metal layer 44, which can serve as a negative electrode active material. Accordingly, in an all-solid battery that has been charged once or more, the precipitation-type negative electrode 40′ may include the current collector 41, the lithium metal layer 44 disposed on the current collector, and the negative electrode coating layer 45 disposed on the metal layer. The lithium metal layer 44 refers to a layer of lithium metal or the like precipitated during the charging process of the battery and may be called a metal layer or a negative electrode active material layer.

The negative electrode coating layer 45 may include metal, a carbon material, or a combination thereof that serves as a catalyst.

The metal may include, for example, gold, platinum, palladium, silicon, silver, aluminum, bismuth, tin, zinc, or a combination thereof, and may be composed of one selected therefrom or an alloy of more than one thereof. When the metal is present in the form of a particle, an average particle diameter (D₅₀) thereof may be about 4 μm or less, for example, 10 nm to 4 μm.

The carbon material may be, for example, crystalline carbon, amorphous carbon, or a combination thereof. The crystalline carbon may be, for example, natural graphite, artificial graphite, a mesophase carbon microbead, or a combination thereof. The amorphous carbon may be, for example, carbon black, activated carbon, acetylene black, Denka black, Ketjen black, or a combination thereof.

When the negative electrode coating layer 45 includes both the metal and the carbon material, a mixing ratio of the metal and the carbon material may be, for example, 1:10 to 2:1 at a weight ratio. In this case, the precipitation of lithium metal can be effectively promoted and the characteristics of the all-solid-state battery can be improved. The negative electrode coating layer 45 may include, for example, a carbon material on which catalyst metal is supported, or a mixture of metal particles and carbon material particles.

The negative electrode coating layer 45 may include, for example, the metal and amorphous carbon, and in this case, the precipitation of lithium metal may be effectively promoted.

The negative electrode coating layer 45 may further include a binder, and the binder may be a conductive binder. Furthermore, the negative electrode coating layer 45 may further include general additives such as a filler, a dispersant, and an ion conductive material.

A thickness of the negative electrode coating layer 45 may be, for example, 100 nm to 20 μm, 500 nm to 10 μm, or 1 μm to 5 μm.

For example, the precipitation-type negative electrode 40′ may further include a thin film on the surface of the current collector, that is, between the current collector and the negative electrode coating layer. The thin film may contain an element that can form an alloy with lithium. The element that may form an alloy with lithium may be, for example, gold, silver, zinc, tin, indium, silicon, aluminum, bismuth, and the like, which may be used alone or as an alloy of more than one thereof. The thin film may further planarize a precipitation shape of the lithium metal layer 44 and further improve the characteristics of the all-solid battery. The thin film may be formed by, for example, a vacuum deposition method, a sputtering method, a plating method, or the like. The thin film may have, for example, a thickness ranging from 1 nm to 500 nm.

### Solid Electrolyte Layer

The solid electrolyte layer 30 may include a sulfide-based solid electrolyte, an oxide-based solid electrolyte, and the like. The specific description of the sulfide-based solid electrolyte and the oxide-based solid electrolyte are the same as above.

In one example, the solid electrolyte included in the positive electrode 20 and the solid electrolyte included in the solid electrolyte layer 30 may include the same compound or different compounds. For example, when both the positive electrode 20 and the solid electrolyte layer 30 include an argyrodite-type sulfide-based solid electrolyte, the overall performance of the all-solid secondary battery can be improved. Furthermore, as an example, when both the positive electrode 20 and the solid electrolyte layer 30 include the coated solid electrolyte described above, the all-solid-state secondary battery can have excellent initial efficiency and life characteristics while implementing a high capacity and a high energy density.

The average particle diameter (D₅₀) of the solid electrolyte included in the positive electrode 20 may be smaller than the average particle diameter (D₅₀) of the solid electrolyte included in the solid electrolyte layer 30. In this case, the overall performance can be improved by maximizing the energy density of the all-solid battery and increasing the mobility of lithium ions. For example, the average particle diameter (D₅₀) of the solid electrolyte included in the positive electrode 20 may be 0.1 μm to 1.0 μm, or 0.1 μm to 0.8 μm, and the average particle diameter (D₅₀) of the solid electrolyte included in the solid electrolyte layer 30 may be 1.5 μm to 5.0 μm, 2.0 μm to 4.0 μm, or 2.5 μm to 3.5 μm. When the above particle diameter ranges are satisfied, the energy density of the all-solid rechargeable battery is maximized and the transfer of lithium ions is facilitated, making it possible to suppress resistance and, thus, improve the overall performance of the all-solid rechargeable battery. Here, the average particle diameter (D₅₀) of the solid electrolyte may be measured with a particle size analyzer using a laser diffraction method. Alternatively, a particle size distribution may be obtained by measuring sizes of about 20 particles selected from a microscope image such as a scanning electron microscope, and a D₅₀value may be calculated from the particle size distribution.

The solid electrolyte layer may further include a binder, in addition to the solid electrolyte. In this case, for the binder, a styrene butadiene rubber, polytetrafluoroethylene, polyvinylidene fluoride, polyethylene, an acrylate-based polymer, or a combination thereof may be used, but the present disclosure is not limited thereto, and any binder used in the art can be used. The acrylate-based polymer may be, for example, butyl acrylate, polyacrylate, polymethacrylate, or a combination thereof.

The solid electrolyte layer may be formed by adding a solid electrolyte to a binder solution, coating a base film with the solution, and drying the resultant. The solvent for the binder solution may be isobutyryl isobutyrate, xylene, toluene, benzene, hexane, or a combination thereof. A process of forming the solid electrolyte layer is widely known in the art, and therefore, a detailed description will be omitted.

A thickness of the solid electrolyte layer may be, for example, 10 μm to 150 μm.

The solid electrolyte layer may further include an alkali metal salt, and/or an ionic liquid, and/or a conductive polymer. The alkali metal salt may be, for example, a lithium salt. A content of the lithium salt in the solid electrolyte layer may be 1 M or more, for example, 1 M to 4 M. In this case, the lithium salt may improve ionic conductivity by improving lithium ion mobility in the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato)borate (LiBOB), lithium oxalyldifluoroborate (LIODFB), lithium difluoro(oxalato)borate (LiDFOB), lithium bis(trifluoro methanesulfonyl)imide, LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

Furthermore, the lithium salt may be an imide-based salt. For example, the imide-based lithium salt may include lithium bis(trifluoro methanesulfonyl) imide, LiTFSI, LiN(SO₂CF₃)₂), lithium bis(fluorosulfonyl) imide, LiFSI, LiN(SO₂F)₂). The lithium salt may maintain or improve ionic conductivity by appropriately maintaining chemical reactivity with an ionic liquid.

The ionic liquid refers to a salt or a room temperature molten salt that has a melting point equal to or lower than a room temperature, is in a liquid state at room temperature, and is composed of only ions.

The ionic liquid may be a compound including a) one or more cations selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, and triazolium-based cations and a mixture thereof, and b) b) BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)2N—, (C₂F₅SO₂)(CF₃SO₂)N—, and (CF₃SO₂)2N—.

The ionic liquid may be, for example, one or more selected from the group consisting of N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, for example, 10:90 to 90:10, 20:80 to 90:10, 30:70 to 90:10, 40:60 to 90:10, or 50:50 to 90:10. A solid electrolyte layer that satisfies the above ranges can maintain or improve ionic conductivity by improving the electrochemical contact area with the electrode. Accordingly, the energy density, discharge capacity, rate characteristics, and the like of the all-solid battery may be improved.

The all-solid battery may include a unit cell having a structure of a positive electrode/a solid electrolyte layer/a negative electrode, a bi-cell structure having a structure of a negative electrode/a solid electrolyte layer/a positive electrode/a solid electrolyte layer/a negative electrode, or a stacked battery in which a structure of a unit battery is repeated.

A shape of the all-solid battery is not particularly limited, and may be, for example, a coin shape, a button shape, a sheet shape, a stack shape, a cylindrical shape, a flat shape, or the like. In addition, the all-solid battery may also be applied to large-sized batteries used in electric vehicles, and the like. For example, the all-solid battery may also be used in a hybrid vehicle such as a plug-in hybrid electric vehicle (PHEV). Furthermore, the all-solid battery may be used in fields that require a large amount of power storage, and for example, may also be used to an electric bicycle, an electric tool, or the like.

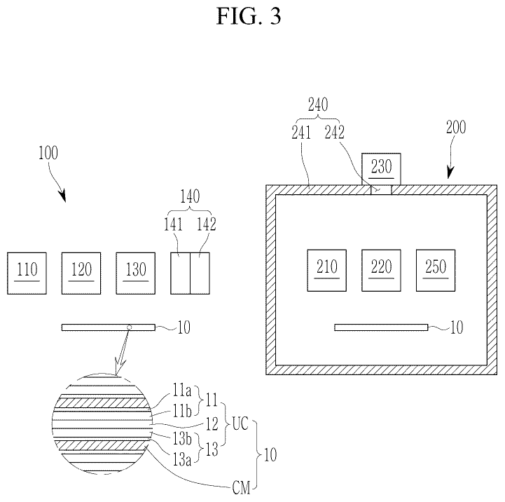

Hereinafter, a test system for an all-solid rechargeable battery according to an embodiment will be described with reference to FIG. 3 to FIG. 8.

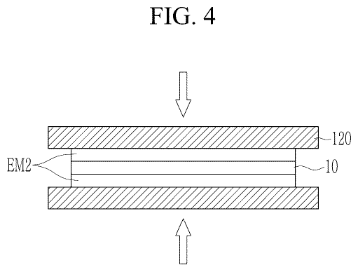

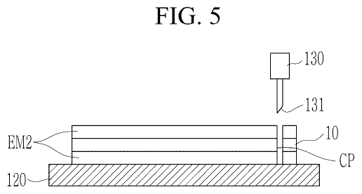

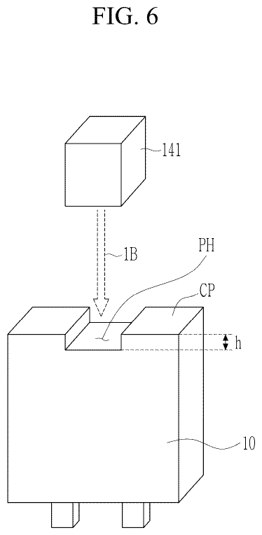

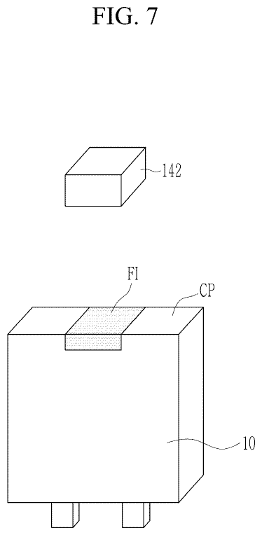

FIG. 3 schematically illustrates a test system for an all-solid rechargeable battery according to an embodiment, FIG. 4 illustrates a state in which a battery specimen is pressed by using a second elastic member loading portion and a second pressing portion of FIG. 3, FIG. 5 illustrates a state in which a portion of a battery specimen is cut by using a cutting portion of FIG. 3, FIG. 6 illustrates a state in which a polishing groove is formed in a portion of a battery specimen by using a polishing portion of FIG. 3, and FIG. 7 illustrates a state in which a protective member is formed in a polishing groove of a battery specimen by using a protective member forming portion of FIG. 3.

As shown in FIG. 3, a test system for an all-solid rechargeable battery according to an embodiment includes a cut surface forming apparatus 100 and a cut surface test apparatus 200.

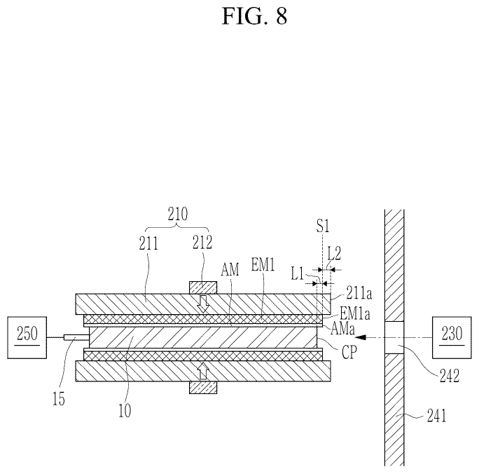

The cut surface forming apparatus 100 may form a cut surface CP on a battery specimen 10. The battery specimen 10 may have a structure in which a stack cell structure in which a plurality of unit cells UC and a buffer member CM are stacked is formed inside a pouch. One unit cell UC may include a positive electrode 11, a negative electrode 13, and a solid electrolyte layer 12. Here, the positive electrode 11 may include a cathode, and the negative electrode 13 may include an anode. The positive electrode 11 may include a positive electrode current collecting layer 11a and a positive electrode active material layer 11b disposed on one surface of the positive electrode current collecting layer 11a. The negative electrode 13 may include a negative electrode current collecting layer 13a and a negative electrode coating layer 13b disposed on one surface of the negative electrode current collecting layer 13a. The solid electrolyte layer 12 may be disposed between the positive electrode active material layer 11b and the negative electrode coating layer 13b. The cut surface CP of the battery specimen 10 may be formed on a side surface opposite to a side surface on which an electrode tab 15 (see FIG. 8) of the battery specimen 10 is disposed.

The cut surface forming apparatus 100 may include a second elastic member loading portion 110, a second pressing portion 120, a cutting portion 130, and a cut surface processing portion 140.

As shown in FIG. 3 and FIG. 4, the second elastic member loading portion 110 may load a second elastic member EM2 on both surfaces of the battery specimen 10. The second elastic members EM2 may be a TEFLON® sheet (PTFE sheet) or the like. In addition, the second pressing portion 120 may press the second elastic members EM2 and the battery specimen 10. In this way, by pressing the battery specimen 10 while the second elastic members EM2 are attached, the stack cells therein may uniformly come into close contact on all surfaces of the battery specimen 10. In addition, because the battery specimen 10 is pressed and the stack cells therein are in close contact, the cut surface CP may be uniformly formed when the battery specimen 10 is cut using the cutting portion 130 in the subsequent process described below.

As shown in FIG. 3 and FIG. 5, the cutting portion 130 may cut a portion of the battery specimen 10 and the second elastic members EM2 to form the cut surface CP on the battery specimen 10. In this case, because the cutting portion 130 has a cross-sectional blade 131, the cut surface CP may form a vertical cross-section.

The cut surface processing portion 140 may improve surface roughness by surface-processing the cut surface CP of the battery specimen 10 that is exposed by the cutting portion 130. The cut surface processing portion 140 may include a polishing portion 141 and a protective member forming portion 142. As shown in FIG. 3 and FIG. 6, the polishing portion 141 may form a polishing groove PH by polishing a portion of the cut surface CP. The polishing portion 141 may improve the surface roughness of the bottom surface of the polishing groove PH by polishing the surface of the cut surface CP. The polishing portion 141 may include an ion beam milling device that etches an object by accelerating ions IB. A height difference h between the bottom surface of the polishing groove PH and the cut surface CP may be about 300 μm.

As shown in FIG. 3 and FIG. 7, the protective member forming portion 142 may form a protective member FI on a portion or all of the cut surface CP. The protective member FI may prevent damage and contamination of the cut surface CP. The protective member FI may be a transparent filler filled in the polishing groove PH. However, the protective member FI is not limited in this regard, and the protective member FI may be a sheet-shaped protective plate disposed on the cut surface CP and the polishing groove PH, or a protective layer formed on the surfaces of the cut surface CP and the polishing groove PH. The protective plate may be melted so as to become in close contact with the surfaces of the cut surface CP and the polishing groove PH, and the protective layer may be applied to be formed on the surfaces of the cut surface CP and the polishing groove PH. The protective member FI may include at least one of polyurethane, ethylene vinyl acetate, polyvinyl butyral, silica gel, and polypropylene. By forming an uneven shape on the surface of the protective member FI, the adhesive force between the protective member FI and the cut surface CP may be improved, and air trapped in the protective member FI may be minimized.

The cut surface test apparatus 200 may test the cut surface CP of the battery specimen 10.

The cut surface test apparatus 200 may include a first elastic member loading portion 210, a first pressing portion 220, an optical test portion 230, a chamber 240, and a charging/discharging portion 250.

FIG. 8 illustrates a state in which a battery specimen is pressed by using the first elastic member loading portion 210 and the first pressing portion 220 of the cut surface test apparatus 200 of a test system for an all-solid rechargeable battery according to an embodiment.

The first elastic member loading portion 210 may load first elastic members EM1 on opposite surfaces of the battery specimen 10. In this case, as shown in FIG. 8, the first elastic member loading portion 210 may align the each of the first elastic members EM1 so that side surfaces EM1a of the first elastic member EM1 protrudes further by a first length L1 than the cut surface CP of the battery specimen 10.

In addition, the first elastic member loading portion 210 attaches alignment members AM to the battery specimen 10 by allowing edge portions AMa of alignment members AM to protrude further by the first length L1 than the cut surface CP of the battery specimen 10. In addition, the first elastic member loading portion 210 may allow the edge portions AMa of the alignment members AM to be aligned on the same surfaces S1 as the side surfaces of the first elastic members EM1. As described above, by using the alignment members AM, the cut surface CP of the battery specimen 10 and the side surfaces of the first elastic members EM1 may be easily aligned. The alignment members AM may be made of a thin film or the like.

The first pressing portion 220 may press both surfaces of the battery specimen 10. The first pressing portion 220 may include pressing plates 211 in contact with surfaces of the first elastic members EM1, and pressure providing portions 212 for providing pressure to the pressing plates 211.

In this case, the first pressing portion 220 may align the pressing plates 211 so that side surfaces 211a of the pressing plates 211 protrude further by a second length L2 than the side surfaces CM1a of the first elastic members EM1.

If the pressing of the battery specimen by the first pressing portion is uneven, the cut portion may not represent the inner portion of the battery specimen, and the cut portion of the battery specimen may be damaged. In this case, an error may occur in the test of the cut surface.

However, in the present embodiment, the side surfaces CM1a of the first elastic members EM1 protrude further by the first length L1 than the cut surface CP of the battery specimen 10, so that the first elastic members EM1 may cover all of the edge portion of the battery specimen 10. Therefore, when pressing the battery specimen using the pressing plates 211, the edge portion of the battery specimen 10 adjacent to the cut surface of the battery specimen 10 may be uniformly pressed by the elastic force of the first elastic members EM1.

In addition, the side surfaces 211a of the pressing plates 211 protrude further by the second length L2 than the side surfaces CM1a of the first elastic members EM1, so that the pressing plates 211 may cover all of the edge portions of the first elastic members EM1. Accordingly, when pressing the battery specimen 10 using the pressing plates 211, the edge portion of the battery specimen 10 and the edge portions of the first elastic members EM1 adjacent to the cut surface CP of the battery specimen 10 may be uniformly pressed.

Accordingly, distortion of the battery specimen 10 may be prevented, and the cut surface CP of the battery specimen 10 may be more accurately tested.

The optical test portion 230 may test the cut surface CP using an optical method.

The chamber 240 may allow the pressing plates 211 and the battery specimen 10 to be disposed therein. The chamber 240 may include a chamber body 241 and a test window 242. The chamber body 241 may seal the pressing plates 211 and the battery specimen 10 to block them from the outside. Because the inside of the chamber body 241 is filled with a vacuum state or a dry gas, it is possible to prevent moisture or air from contacting the cut surface of the battery specimen.

The test window 242 may be installed in the chamber body 241 and may be disposed to correspond to the cut surface CP of the battery specimen 10. The test window 242 may be made of a transparent material. Accordingly, the cut surface CP of the battery specimen may be easily observed and tested using the test window 242.

The charging/discharging portion 250 may be electrically connected to the electrode tab 15 (see FIG. 8) of the battery specimen 10 to charge and discharge the battery specimen 10. Accordingly, the battery specimen 10 may be tested more accurately by pressing the battery specimen 10 and performing the charging and discharging process at the same time.

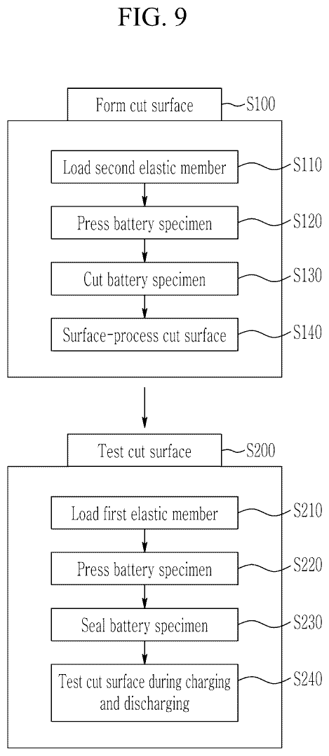

Hereinafter, a test method using a test system for an all-solid rechargeable battery according to an embodiment will be described in detail with reference to FIG. 9.

FIG. 9 illustrates a flowchart of a test method for an all-solid rechargeable battery according to an embodiment.

As shown in FIG. 9, in the test method for the all-solid rechargeable battery according to the embodiment, first, the cut surface CP is formed on the battery specimen 10 (step S100).

Hereinafter, a method of forming the cut surface CP on the battery specimen 10 will be described in detail with reference to the accompanying drawings.

As shown in FIG. 4 and FIG. 9, second elastic members EM2 are loaded on opposite surfaces of the battery specimen 10 using the second elastic member loading portion 110 (step S110). Then, the second elastic members EM2 and the battery specimen 10 are pressed for a predetermined time, for example, for about 10 minutes using the second pressing portion 120 (step S120). In this way, by pressing the battery specimen 10 while the second elastic members EM2 are attached, the stack cells therein may uniformly come into close to all surfaces of the battery specimen 10. In addition, because the battery specimen 10 is pressed and the stack cells therein are in close contact, the cut surface CP may be uniformly formed when the battery specimen 10 is cut using the cutting portion 130 in the subsequent process.

Then, as shown in FIG. 5 and FIG. 9, a portion of the battery specimen 10 and the second elastic members EM2 is cut using the cutting portion 130 to form the cut surface CP on the battery specimen 10 (step S130). In this case, because the cutting portion 130 has a cross-sectional blade 131, the cut surface CP may form a vertical cross-section.

Then, as shown in FIG. 6, FIG. 7, and FIG. 9, the cut surface CP is surface-processed using the cut surface processing portion 140 (step S140). To this end, first, a portion of the cut surface CP is polished using the polishing portion 141 to form the polishing groove PH. Then, the protective member FI is formed on the cut surface CP using the protective member forming portion 142. In this case, the protective member FI may be a transparent filler filled in the polishing groove PH. The protective member FI may be formed by immersing the cut surface CP of the battery specimen 10 in a liquid protective member solution, thinly applying a liquid protective member solution to the surface of the cut surface CP, and then thermally curing or photocuring the same.

The protective member FI may protect the cut surface CP exposed in the polishing groove PH.

Next, as shown in FIG. 8 and FIG. 9, the cut surface CP of the battery specimen 10 is tested (step S200).

A method of testing the cut surface CP of the battery specimen 10 will be described in detail with reference to the accompanying drawings.

First, first elastic members EM1 are positioned on opposite surfaces of the battery specimen 10 using the first elastic member loading portion 240 (step S210). In this case, the side surfaces of the first elastic members EM1 may be aligned to protrude further by the first length L1 than the cut surface CP of the battery specimen 10. In addition, the side surfaces 211a of the pressing plates 211 may be aligned to protrude further by the second length L2 than the side surface CM1a of the first elastic member EM1.

Then, both surfaces of the battery specimen 10 are pressed using the first pressing portion 220 (step S220).

The pressing plates 211 and the battery specimen 10 are positioned inside the chamber body 241 and blocked from the outside (step S230).

Then, while charging and discharging the battery specimen 10 using the charging/discharging portion 250, the cut surface CP is optically tested through the test window 242 installed in the chamber body 241 (S240).

While this disclosure has been described in connection with what is presently considered to be practical embodiments, it is to be understood that the disclosure is not limited to the disclosed embodiments. On the contrary, the disclosure covers various modifications and equivalent arrangements included within the spirit and scope of the appended claims.

### DESCRIPTION OF SYMBOLS

10: battery specimen
100: cut surface forming apparatus
110: second elastic member loading portion
120: second pressing portion
130: pressure providing portion
140: cut surface processing portion
200: cut surface test apparatus
210: first elastic member loading portion
220: first pressing portion
230: optical test portion
240: chamber
250: charging/discharging portion

What is claimed is:

1. A test system for an all-solid rechargeable battery, the test system comprising:
a cut surface forming apparatus configured to form a cut surface on a battery specimen that includes a positive electrode, a negative electrode, and a solid electrolyte layer, and a cut surface test apparatus configured to test the cut surface of the battery specimen, wherein the cut surface test apparatus includes:
an elastic member loading portion configured to position elastic members on opposite surfaces of the battery specimen, a pressing portion that presses the opposite surfaces of the battery specimen, and an optical test portion configured to optically test the cut surface, wherein the elastic member loading portion is configured to align the elastic members so that side surfaces of the elastic members protrude more than the cut surface of the battery specimen.

2. The test system of claim 1, wherein the pressing portion includes:
pressing plates in contact with surfaces of the elastic members, and a pressure providing portion that provides pressure to the pressing plates, and wherein the first pressing portion is configured to align the pressing plates so that side surfaces of the pressing plates protrude more than side surfaces of the elastic members.

3. The test system of claim 2, wherein the elastic member loading portion is configured to attach an alignment member to the battery specimen by allowing an edge portion of the alignment member to protrude further than the cut surface of the battery specimen, and the elastic member loading portion is configured to allow the edge portion of the alignment member to be aligned on the the side surfaces of the elastic members.

4. The test system of claim 2, wherein the elastic member loading portion is a first elastic member, the elastic members are first elastic members, and the pressing portion is a first pressing portion and wherein the cut surface forming apparatus includes:
a second elastic member loading portion that is configured to position second elastic members on the opposite surfaces of the battery specimen, a second pressing portion that is configured to press the second elastic member sand the battery specimen, and a cutting portion of the cut surface forming apparatus that is configured to cut a portion of the battery specimen and the second elastic members to form the cut surface on the battery specimen.

5. The test system of claim 4, wherein the cut surface forming apparatus further includes a cut surface processing portion that is configured to surface-process the cut surface.

6. The test system of claim 5, wherein the cut surface processing portion includes:
a polishing portion that is configured to form a polishing groove by polishing a portion of the cut surface, and a protective member forming portion that is configured to form a protective member on the cut surface.

7. The test system of claim 5, wherein the cutting portion includes a cross-sectional blade.

8. The test system of claim 2, wherein the cut surface test apparatus further includes a chamber in which the pressing plates are disposed, and wherein the chamber includes:
a chamber body that blocks the pressing plate from outside of the chamber body, and a test window that is installed on the chamber body and disposed to correspond to the cut surface of the battery specimen.

9. The test system of claim 1, wherein the cut surface test apparatus further includes a charging/discharging portion that is configured to be electrically connected to an electrode tab of the battery specimen and to charge and discharge the battery specimen.

10. A test method for an all-solid rechargeable battery, the test method comprising:
forming a cut surface on a battery specimen that includes a positive electrode, a negative electrode, and a solid electrolyte layer; and
testing the cut surface of the battery specimen, wherein the testing of the cut surface includes:
positioning elastic members on opposite surfaces of the battery specimen, aligning side surfaces of the elastic members so that the side surfaces of the elastic members protrude more than the cut surface of the battery specimen, pressing surfaces of the elastic members and the battery specimen using a pressing portion, and optically testing the cut surface.

11. The test method of claim 10, wherein the first pressing portion includes:
pressing plates in contact with surfaces of the elastic members, and a pressure providing portion that provides pressure to the pressing plates, and wherein, in the pressing of both surfaces of the battery specimen, side surfaces of the pressing plates are aligned so the side surfaces of the pressing plates protrude more than side surfaces of the elastic members.

12. The test method of claim 11, wherein the elastic member loading portion is a first elastic member, the elastic members are first elastic members, and the pressing portion is a first pressing portion, and wherein the forming of the cut surface on the battery specimen includes:
positioning second elastic members on the opposite surfaces of the battery specimen, pressing the second elastic members and the battery specimen, and forming the cut surface by cutting a portion of the battery specimen and the second elastic members using a cutting portion.

13. The test method of claim 12, wherein the cutting portion includes a cross-sectional blade.

14. The test method of claim 13, wherein the forming of the cut surface on the battery specimen further includes surface-processing the cut surface, and wherein the surface-processing of the cut surface includes:
forming a polishing groove by polishing a portion of the cut surface, and forming a protective member on the cut surface.

15. The test method of claim 12, wherein the testing of the cut surface further includes:
positioning the pressing plates and the battery specimen inside a chamber body and blocking the pressing plates and the battery specimen from outside of the chamber body, and charging and discharging the battery specimen, and wherein the cut surface is optically tested while charging and discharging the battery specimen through a test window installed in the chamber body.
